(19) United States
(12) Patent Application Publication
(10) Pub. No.: US 2011/0067261 A1
(43) Pub. Date: Mar. 24, 2011

(54) MOISTURE REMOVAL FROM RAILCARS

(75) Inventor: James A. Kweeder, Chesterfield, VA (US)

(73) Assignee: Honeywell International Inc., Morristown, NJ (US)

(21) Appl. No.: 12/565,553

(22) Filed: Sep. 23, 2009

(51) Int. Cl. F26B 19/00; F26B 25/02

(52) U.S. Cl. 34/443; 34/90

(57) ABSTRACT

A method of preventing a porous product positioned within an interior area of a railcar bin from caking includes positioning a first vertical pipe at least partly into the product, positioning a second vertical pipe at least partly into the product, capturing moisture from within the granular product and within the railcar bin through the first and second vertical pipes, and expelling the moisture from the railcar bin. The first and second vertical pipes each has a first open end and a second open end and may optionally include apertures along a length of each of the vertical pipes. The second vertical pipe is spaced from the first vertical pipe at a distance sufficient to create natural convection.

### TECHNICAL FIELD

The present invention is related generally to the field of reducing and removing moisture from a confined space. In particular, the present invention is a system and method for reducing and removing moisture from a railcar bin.

### BACKGROUND

Materials which are normally free-flowing, such as for example, granular material, can become hard and agglomerate, or cake, when exposed to heat and/or humidity. These conditions may occur when the material is being transported, particularly when the material is loaded into a container straight off of the production line while the temperature of the material is still hot. Because hot materials typically contain residual moisture, when the hot material is loaded into the container, moisture migration can occur. The heat and moisture slowly evaporate from the material and migrate upwards towards the air, which is generally cooler, and condenses either in the head space of the container or within the cooler, upper regions of the material load.

One method of moving materials between locations is by loading the product onto a railcar bin and then transporting the product on the railway system. For example, granular products such as ammonium sulfate are commonly transported through the railway system. Moisture migration can be further exacerbated when the material is located in a railcar bin because the railcar bin may be enclosed in order to protect the material from the environment. Thus, even if the material itself is not hot enough to create the condensation, the roof of the railcar bin is often cool enough to create moisture condensation on the roof of the railcar bin which then falls back down on the material. This condensation can result in caking and/or damage to the material.

### SUMMARY

In one embodiment, the present invention is a system for reducing moisture from a porous product positioned in a railcar. The system includes a first conduit and a second conduit positioned vertically within the railcar with the second conduit being spaced from the first conduit at a distance sufficient to stimulate natural convection. Each of the conduits has a first open end and a second open end and may also include apertures positioned along a length of each of the conduits. The first open ends of the conduits are positioned within the porous product and the second open ends of the conduits are positioned outside of the porous product.

In another embodiment, the present invention is a method for reducing moisture within a pile of granular product positioned in a railcar. The method includes filling an interior area of the railcar with a granular product, providing a first pipe within the granular product such that a portion of the pile of the granular product covers at least a first end of the first pipe, capturing heat and humidity from within the granular product positioned in the interior area of the railcar using the first pipe, and venting the heat and humidity from the railcar. The first pipe creates natural convection within the interior area of the railcar.

In yet another embodiment, the present invention is a method of preventing a porous product positioned within an interior area of a railcar bin from caking. The method includes positioning a first vertical pipe at least partly into the product, positioning a second vertical pipe at least partly into the product, capturing moisture from within the granular product and within the railcar bin through the first and second vertical pipes, and expelling the moisture from the railcar bin. The first and second vertical pipes each has a first open end and a second open end and may optionally include apertures along a length of each of the vertical pipes. The second vertical pipe is spaced from the first vertical pipe at a distance sufficient to stimulate natural convection.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a schematic view of a moisture removal system according to an embodiment of the present invention.

FIG. 2 is a schematic diagram of a moisture removal system according to a second embodiment of the present invention used in testing.

FIG. 3 is a pile aeration cooling curve graph representative of testing data related to the second embodiment of the present invention

FIG. 4 is a pile segregation graph representative of testing data related to the second embodiment of the present invention.

FIG. 5 is a screen fraction graph representative of testing data related to the second embodiment of the present invention.

FIG. 6 is a moisture graph representative of testing data related to the second embodiment of the present invention.

### DETAILED DESCRIPTION

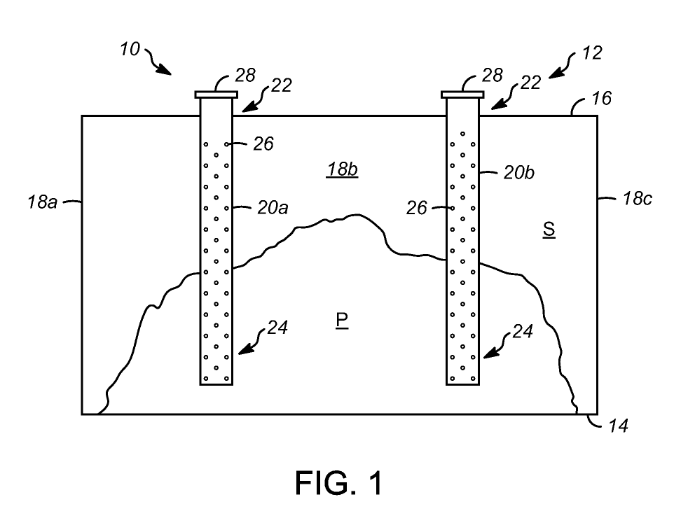

FIG. 1 shows a schematic view of a moisture removal system 10 positioned vertically within a railcar bin 12. The railcar bin 12 may be used to transport a product P, such as a granular particle, from one location to another. In one embodiment, the product P may be poured into the railcar bin 12 such that it forms a pile. Because the product P itself is granular, the pile of the product P will be porous. As used within the specification, the term “porous” is defined as a product which, due to its granular properties, allows gas and liquid to pass through the product as a whole. Because the porous pile is made up of individual particles, the monolithic whole of the pile is permeable to air/ventilation.

When the product P is loaded into the railcar bin 12, the product P may have an elevated temperature from being processed. In one embodiment, the product P may have a temperature of between about 35 and about 40 degrees Celsius. However, at temperatures sufficiently removed from ambient temperature, moist air may form within the warmer regions of the pile and subsequently contact a cooler area, for example, the top of the railcar bin or the upper extremities of the pile itself, and cause condensation. The occluded moisture vaporized by heat trapped within the pile and its subsequent condensation in the cooler area on top of the pile can result in caking of the product P. For example, in one embodiment, the product P is ammonium sulfate. When the ammonium sulfate is loaded into the railcar bin 12, the ammonium sulfate typically contains residual water and heat. If the residual water and heat is allowed to remain within the ammonium sulfate, the heat and humidity can cause the ammonium sulfate to cake.

The moisture removal system 10 uses pile aeration to provide a clear pathway for moisture to travel from within a product P pile, past the headspace in the railcar bin 12, and out to the environment. Pile aeration functions to remove residual heat inside the pile, provide an alternative pathway for the warm, moist air to exit the pile, and provide additional air to dilute the moist air and keep it above its dew point in cooler regions of the pile. Because the moisture bypasses the headspace of the railcar bin 12, the evaporated heat and humidity within the product P is prevented from condensing and falling back onto the product P. By removing the heat and water from the product P and expelling the moisture out of the railcar bin 12, caking of the product can be either minimized or avoided.

The railcar bin 12 housing the product P generally includes a floor 14, a ceiling 16 and four sidewalls, three of which are shown, 18a, 18b and 18c, connecting the floor 14 and the ceiling 16 to create an enclosed space S. At least one of the floor 14, ceiling 16 and sidewalls 18a, 18b, 18c and 18d can be opened to load and unload the product P from the railcar bin 12. In one embodiment, the product P is loaded into the railcar bin 12 by opening the ceiling 16 and pouring the product P into the enclosed space S. The product P can then be unloaded from the railcar bin 12, for example, by opening the floor 14 and allowing the product P to fall from the enclosed space S.

The moisture removal system 10 is positioned within the enclosed space S and includes at least a first conduit 20a and a second conduit 20b (collectively referred to as “conduits 20”). Each of the conduits 20 has a first open end 22 and a second open end 24. The conduits 20 are formed of a material that is compatible with the product P and that is sufficiently rigid such that it is capable of withstanding at least the force of natural convection flowing through the conduits 20. In addition, the conduits 20 must be able to withstand lateral forces incurred during loading and unloading operations as well as any potential shifting of the product P during railcar movements. In one embodiment, the conduits 20 are formed of stainless steel, carbon steel or plastic.

Moisture migration from the pile of product P is driven by both residual moisture and the temperature gradient in the product P. To the extent that the conduits 20 remove either heat or moisture, moisture migration will be effectively attenuated. Removal of both heat and moisture would further increase the effectiveness of the moisture removal system 10. Thus, in one embodiment, each of the conduits 20 also includes a plurality of apertures 26 positioned along a length of the conduit 20 between the first end 22 and the second end 24 to help facilitate the removal of both heat and moisture from within the pile of the product P. Whether the conduits 20 include apertures 26 will depend in part on the product P being transported. For example, the conduits 20 may include apertures 26 where the particle size of the product P is generally larger and easier to exclude from the apertures 26 without making the apertures 26 so small as to easily clog. In one embodiment, the conduits may include apertures 26 when the product is fertilizer. When the product P includes more finely sized particles, for example, granulated sugar, the conduits 20 may not include apertures 26 as the particles may be pulled into the conduit 20 through the apertures 26.

When apertures 26 are positioned along the length of the conduits 20, the apertures 26 are sized such that they allow air to pass into the conduit 20 but do not allow the product P to enter the conduit 20. The size and number of apertures 26 of each of the conduits 20 are chosen such that a draft is induced through the conduits 20. Thus, the design of the conduits will depend on the size of the enclosed space S of the railcar bin 12. While the moisture removal system 10 is designed to induce draft, a steady draft is often not desirable. For example, many granular products are susceptible to degradation from atmospheric moisture. In those cases, a continuing induced draft could be detrimental.

As can be seen in FIG. 1, the conduits 20 are suspended from the ceiling 16 at their first ends 22. The first ends 22 of the conduits are open and extend through the ceiling 16 such that they are exposed to the outside environment. The conduits 20 extend vertically from the ceiling 16 such that the second ends 24 of the conduits 20 are positioned above the floor 14 of the railcar bin 12. The second ends 24 of the conduits 20 are open and are often positioned within the product P pile. While the second ends 24 of the conduits 20 do not necessarily reach the floor 14, the second ends 24 extend substantially down into the product P in order to maximize pile aeration of the product P.

The conduits 20 extend vertically from the ceiling 16 of the railcar bin 12 and into the product P to provide a “chimney”, allowing warm moisture from within the product P to be pulled from the product P and into the conduits 20. The force driving the warm moisture to travel through the conduits 20 and out of the railcar bin 12 is buoyancy driven convection. Thus, rather than using an external source to transport the heat from the product P to the outside environment, the moisture removal system 10 uses the temperature gradients created by the density differences in the moisture within the product P and the cooler air above the product P to cause fluid motion. The fluid motion causes the moisture to travel from the product P and the headspace of the railcar bin 12 through the conduits 20 and out of the enclosed space S of the railcar bin 12 at the first ends 22 of the conduits. The moisture is pulled from the product P at the open second ends 24 of the conduits 20 and through the apertures 26 into the conduits 20 where it is then pulled upwards within the conduits 20. Because the moisture from the product P travels through the conduits 20 where it is expelled to the natural environment, the moisture does not enter the headspace of the railcar bin 12, preventing possible condensation on the ceiling 16 that may then fall back down onto the product P. In the case where the conduits 20 include apertures 26, because the apertures 26 extend along the entire length of the conduits 20, heat and humidity in the headspace are also pulled into the conduit 20 and removed from the railcar bin 12.

In an alternative embodiment, the first ends 22 of the conduits 20 are positioned within the railcar bin 12 and discharge the heat and moisture into the headspace of the railcar bin 12. In this case, the headspace of the railcar bin 12 is equipped with ventilation to expel the heat and moisture from the headspace of the railcar bin 12 to the outside environment in order to prevent moisture build-up and subsequent condensation with the railcar bin 12.

The first and second conduits 20a and 20b are spaced from each other at a distance to stimulate natural convection. Thus, the radius of natural convection produced as a result of each conduit 20 is first determined. After the radius of natural convection is determined, the conduits 20a and 20b are positioned at a distance from one another to generate natural convection throughout the railcar bin 12. In one embodiment, the conduits 20 produce a natural convection radius of about 4 feet and are positioned about 8 feet from one another. Although the moisture removal system 10 is depicted in FIG. 1 as including only two conduits 20a and 20b, the moisture removal system 10 may include any number of conduits without departing from the intended scope of the present invention.

In one embodiment, the first ends 22 of the conduits 20 include an aircap 28 to protect the product P from the natural environment while still allowing release of gas. For example, the aircap 28 may prevent rain from entering the railcar bin 12 and contacting the product P. The aircap 28 also helps to induce draft as the railcar moves in order to aid in removing moisture and heat from within the railcar bin 12. In addition, the aircap 28 may also prevent the product P from exiting the railcar bin 12 as the moisture is being expelled due to the natural convection pulling the moisture from within the railcar bin 12 and through the conduits 20 to the outside environment.

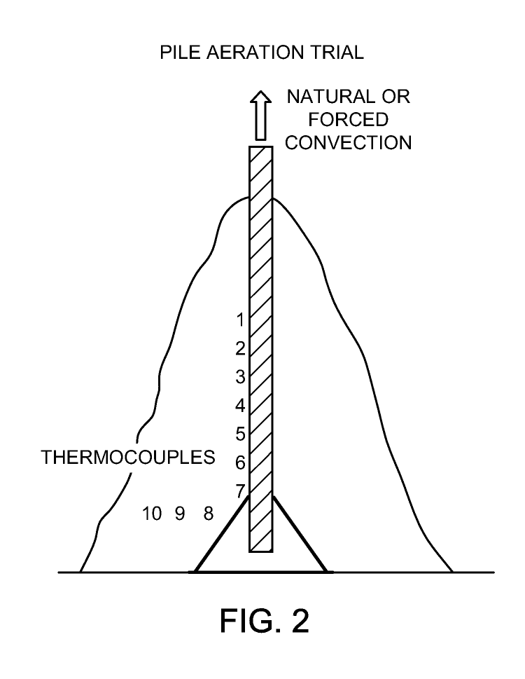

Although FIG. 1 depicts the railcar bin 12 as being enclosed and including a ceiling 16, the present invention may also be used in conjunction with railcar bin embodiments in which the railcar bin 12 is not enclosed and is open to the environment. For example, in one embodiment, the railcar bin 12 does not include a ceiling. In this case, the conduits 20 may be positioned on stands on the floor 14 of the railcar bin 12 such that the second ends 24 are positioned within the product P pile and the first ends 22 extend from the product P pile. See, for example, FIG. 2. While the first ends 22 of the conduits 20 may not extend out of the railcar bin 12, the first ends 22 of the conduits are still exposed to the environment and can thus pull heat and humidity from the pile and expel the moisture into the environment.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

To evaluate the feasibility of pile aeration as a method to control caking, a 4″ diameter polyvinylchloride (PVC) pipe was buried in a vertical position inside approximately the center of a 200 ton pile of granular ammonium sulfate. FIG. 2 shows a schematic diagram of the pipe positioned within the pile. This experiment evaluated natural convection with a pipe having no apertures to allow air entry along its length. The pipe and stand were instrumented with 7 thermocouples spaced at 1 foot intervals up the pipe and with 3 thermocouples spaced at 3 foot internals along the instrument cable. This arrangement allowed monitoring of temperatures along the central axis and in a region away from the pipe. Temperature readings were collected on a generally daily basis. However, as ambient temperature approached, semi-daily readings were adequate. A recording thermometer and hygrometer were placed within the pile to record the ambient conditions.

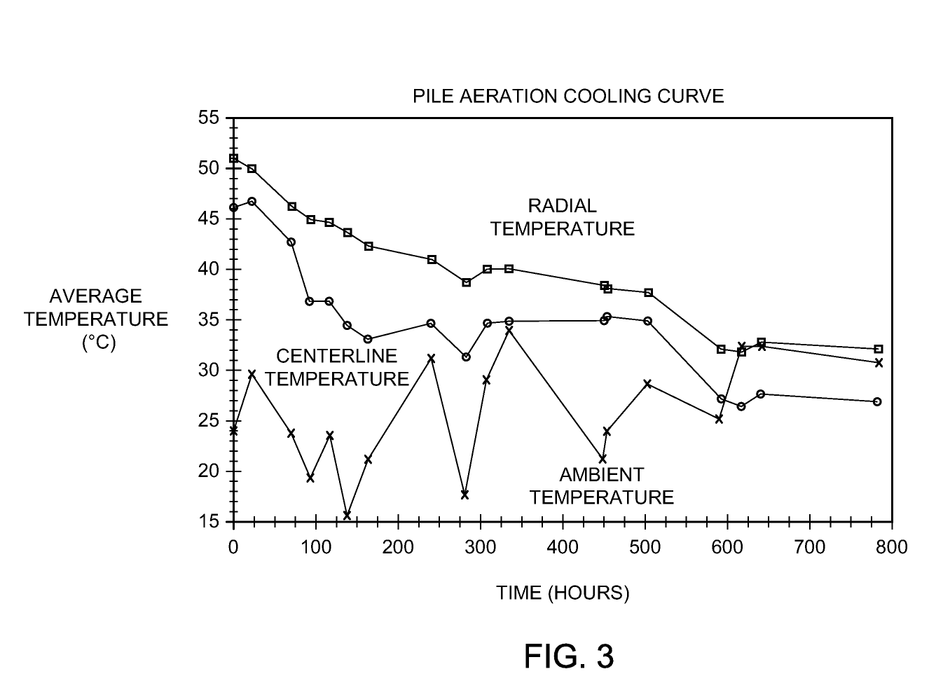

FIG. 3 shows temperature readings and cooling curves for the centerline and radial portions of the pile. The centerline temperatures were measured inside the aeration pipe and the radial temperatures were measured along the thermocouple cable. The ambient temperature is also plotted in FIG. 3. As can be seen in FIG. 3, the centerline temperature was consistently at least about 5 degrees cooler than the region removed from the aeration pipe. In addition, during the first 100 hours of the trial, the cooling in the center region was greater than in the remainder of the pile. In comparing the ambient temperature to the cooling curves, it is seen that pile cooling was influenced by the ambient air temperature even without an increase in air circulation through the pile. Within a day of the pile being built, the pile developed a crust of granular product. The bridging between the granular was very fragile and the material was easily dug into to produce a flow.

Once the temperature dropped to below about 40° C., the pile was excavated and the pile was sliced to the center location. The pile was excavated after about 10 days by using a backhoe to slice towards the center of the pile in nominal three foot intervals. After each slice, a physical examination was made to determine the extent and location of caking, samples were taking and features were photographed.

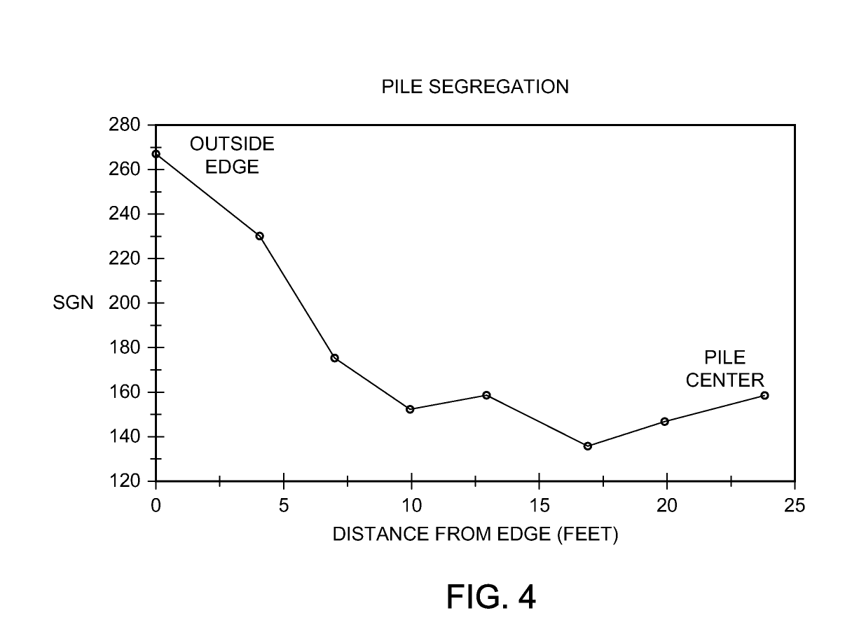

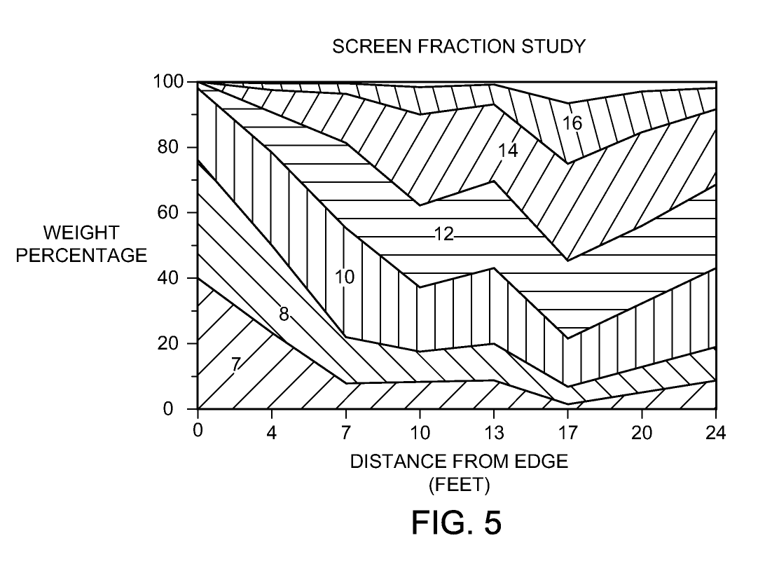

FIGS. 4 and 5 show screening data for samples taken from the pile excavation. FIG. 4 shows pile segregation presented as a composite size guide number (SGN) and FIG. 5 shows screen fractionation as the cumulative totals for the various fractions. SGN is a method to characterize an “average” size of fertilizer particles and is the median dimension expressed in millimeters to the second decimal and then multiplied by 100. It is the particle size which divides the mass of all particles into two equal halves, one having the larger size particles and the other half having the smaller size particles.

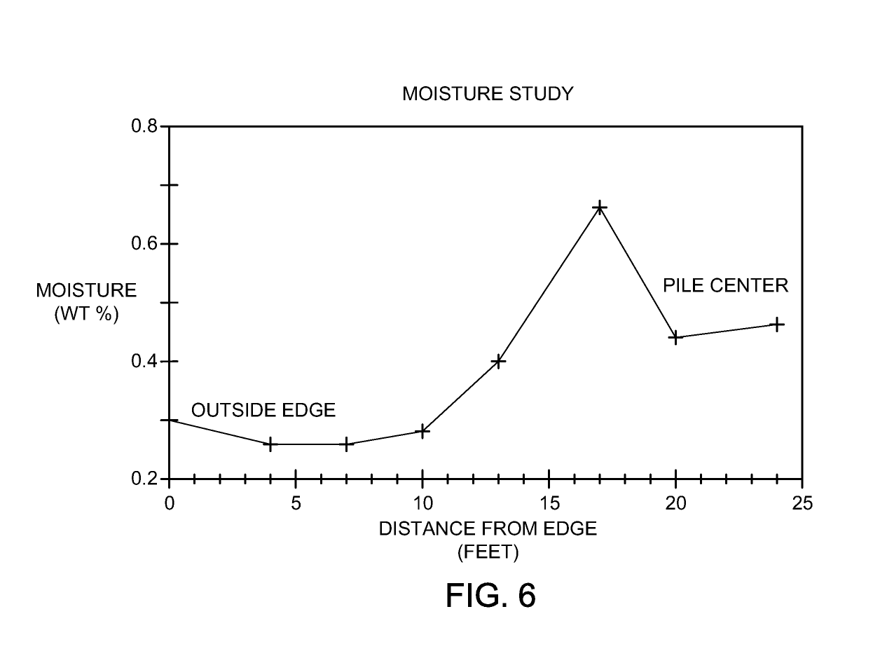

FIGS. 4 and 5 show that finer materials tend to sift down into the center of the pile while the larger materials tend to roll down the exterior. Thus, with time, there tends to be a build-up of finer materials towards the pile center and granular particles towards the outside of the pile. Having the finer materials poured down into the pile center increases the thermal load in the center region. The finer materials will also tend to pack into the voids between the larger crystals, making air circulation more difficult. However, the finer materials also have less moisture than the granular particles. Larger particles tend to have more moisture due to the decrease in crystalline perfection with increasing size. Thus, the fines segregation could be partially responsible for the moisture “spike” discussed below with regard to FIG. 6. Also, the accumulation of finer materials in the pile center will also concentrate residual heat BTU's close to the centerline of the pile. Thus, only a relatively modest increase in moisture loading should result.

FIG. 6 shows the moisture analysis for the pile. The granular product moistures ran at about 0.4 to about 0.8% coming from the screening. Thus, very little, if any moisture reduction took place near the center of the pile. The outer regions, which were closer to the surface and had less fine material to obstruct air circulation, reduced the moisture levels. The high-point of the graph is an artifact of that region being cooled the least by either the center conduit or because of its proximity to the pile surface. The reduced moisture to either side of the peak was most likely due to evaporation and diffusion of that moisture out of the pile. The location of the “spike” is the area that is farthest from an exit point (pile surface or the center ventilation point). Thus, the moisture distribution is expected. As can be seen from FIG. 6, while there was some reduction in moisture at the centerline, the periphery of the pile had superior moisture removal. Because the caking mechanism was broken in the pile center, the data suggests that this was due to cooling within the center region and not to extraction or dilution of moisture with air.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A system for reducing moisture from within a porous pile positioned within a railcar, the system comprising:
a first conduit having a first open end and a second open end, wherein the first conduit is positioned vertically within the railcar such that the first open end of the first conduit is positioned within the porous pile and the second open end is positioned outside of the porous pile; and
a second conduit having a first end and a second end, wherein the second conduit is positioned vertically within the railcar such that the first open end of the second conduit is positioned within the porous pile and the second open end is positioned outside of the porous pile;
wherein the second conduit is spaced from the first conduit at a sufficient distance to stimulate natural convection.

2. The system of claim 1, wherein the first and second conduits are formed of one of stainless steel, carbon steel and plastic.

3. The system of claim 1, wherein the first open ends of the first and second conduits are spaced from a floor of the railcar.

4. The system of claim 1, wherein the first conduit has a plurality of apertures positioned along a length of the first conduit.

5. The system of claim 1, wherein the second open ends of each of the first and second conduits extend from the railcar.

6. The system of claim 5, wherein the second open ends of the first and second conduits include an aircap.

7. The system of claim 1, wherein the second ends of each of the first and second conduits bypass a headspace of the railcar.

8. The system of claim 1, wherein the first conduit and the second conduit expel moisture from the railcar.

9. A method of reducing moisture within a pile of granular product positioned in a railcar, the method comprising:
providing a first pipe positioned generally vertically within an interior area of the railcar, the first pipe comprising a first open end and a second open end;
filling the railcar with the granular product such that a portion of the pile of the granular product covers at least the first end of the first pipe;
capturing heat and humidity from within the granular product positioned in the interior area of the railcar using the first pipe; and
venting the heat and humidity through the first pipe and from the railcar.

10. The method of claim 9, further comprising providing a second pipe positioned generally vertically within the interior area of the railcar to create natural convection, wherein the pile of the granular product covers at least a first open end of the second pipe.

11. The method of claim 9, wherein the second open end of the first pipe is exposed externally of the interior area of the railcar.

12. The method of claim 9, wherein the first pipe includes a plurality of holes along lengths of the pipe.

13. The method of claim 9, wherein the granular product is at a temperature of at least about 35 degrees Celsius when being filled into the railcar.

14. The method of claim 9, further comprising capturing heat and humidity from a headspace of the railcar.

15. The method of claim 9, wherein venting the heat and humidity from the railcar comprises bypassing a headspace of the railcar.

16. A method of preventing a porous product positioned within an interior area of a railcar bin from caking, the method comprising:
positioning a first vertical pipe at least partly into the porous product, wherein the first vertical pipe has a first end, a second end and a plurality of apertures;
positioning a second vertical pipe at least partly into the porous product, wherein the second vertical pipe has a first end, a second end and a plurality of apertures, and wherein the second vertical pipe is spaced from the first vertical pipe;
capturing moisture from within the product and within the railcar bin through the first and second vertical pipes; and
expelling the moisture from the railcar bin.

17. The method of claim 16, wherein expelling the moisture from the railcar bin comprises bypassing a headspace of the railcar bin.

18. The method of claim 16, wherein the first ends of the first and second vertical pipes extend outside of the railcar and wherein expelling the moisture from the railcar bin comprises venting the moisture from the railcar bin through the first ends of the first and second vertical pipes.

19. The method of claim 16, wherein capturing moisture from within the porous product and within the railcar bin comprises using natural convection produced by the first and second vertical pipes.

20. The method of claim 16, wherein positioning the first and second vertical pipes at least partly into the porous product comprises positioning the second ends of the first and second vertical pipes at a distance from a floor of the railcar bin.
